(19) United States
(12) Patent Application Publication
(10) Pub. No.: US 2010/0000484 A1
(43) Pub. Date: Jan. 7, 2010

(54) LIQUID FUEL COMPOSITIONS

(76) Inventors: Alison Felix-Moore, Chester (GB); Jurgen Johannes Jacobus Louis, Hamburg (DE); Johanne Smith, Chester (GB)

Correspondence Address: SHELL OIL COMPANY, P O BOX 2463, HOUSTON, TX, 772522463, US

(21) Appl. No.: 12/496,091

(22) Filed: Jul. 1, 2009

(30) Foreign Application Priority Data
Jul. 2, 2008 (EP) 08159556.3

(51) Int. Cl. F02B 43/00; C10L 1/19

(52) U.S. Cl. 123/1 A; 44/388

(57) ABSTRACT

The present invention provides a liquid fuel composition comprising a major portion of a base fuel suitable for use in an internal combustion engine and from 0.5 to 25 vol %, based on the liquid fuel composition, of a C1-C5 hydrocarbyl valerate ester composition.

### FIELD OF THE INVENTION

The present invention relates to liquid fuel compositions comprising a major portion of a base fuel suitable for use in an internal combustion engine, in particular to liquid fuel compositions comprising a major portion of a base fuel suitable for use in an internal combustion engine and a C1-C5 hydrocarbyl valerate ester composition.

### BACKGROUND OF THE INVENTION

Valerate esters, such as ethyl valerate (also called ethyl pentanoate), are esters commonly used in fragrance and flavouring applications.

JP57-115490-A1 (K.K. My-Skincare-Laboratories & Daikyu K.K.) discloses a kerosene deodoriser containing 1 kind or 2 or more kinds of lower fatty acid esters. Esters of valeric acid are included in the description as examples of possible lower fatty acid esters.

JP07-018269-A1 (Riken Koryo Kogyo K.K.) discloses fuel additives for suppressing the unpleasant odor characteristic of the fuel produced during incomplete combustion of said fuel. Ethyl pentanoate is disclosed as an ester useful as an odor suppressing additive, and gasoline compositions comprising 0.2 wt. % ethyl pentanoate and commercial light oils compositions comprising 0.3 wt. % ethyl pentanoate are disclosed therein.

WO 01/36354 A1 (Ronyak) discloses compositions containing an odor-emitting hydrocarbonaceous material and an odor-suppressing amount of an aldehyde or a ketone, and a carboxylic acid ester. Ethyl valerate is disclosed as a carboxylic acid ester (claim 18) and gasoline and diesel fuels are disclosed as an odor-emitting hydrocarbonaceous material (claim 9).

U.S. Pat. No. 2,228,662 and U.S. Pat. No. 2,334,006 (Standard Oil Company) discloses the addition of esters to motor fuels consisting essentially of branched chain paraffin hydrocarbons and having a relatively high anti-knock value to increase the anti-knock quality thereof. The motor fuels to which the ester is added in both U.S. Pat. No. 2,228,662 and U.S. Pat. No. 2,334,006 are described as “consisting essentially of branched chain paraffin hydrocarbons”, and more specifically the base fuels to which the ester is added are described as branched chain paraffin stocks comprising from five to twelve carbon atoms per molecule. U.S. Pat. No. 2,228,662 and U.S. Pat. No. 2,334,006 further describe that the base fuel of invention disclosed therein “usually is not alone a satisfactory motor fuel, for it is usually necessary that more volatile constituents, such as natural gasoline for example, be blended with it to make a finished fuel having the desired volatility or distillation curve, so that the fuel will have the desired characteristics relating to starting, acceleration, etc.”, and that such blending is objectionable because the more volatile blending stocks usually have relatively low anti-knock values.

U.S. Pat. No. 2,228,662 and U.S. Pat. No. 2,334,006 disclose that the proportion of the esters added to the base fuel should be such that the ester comprises 10 to 50 percent by volume of the finished fuel. The examples of U.S. Pat. No. 2,228,662 and U.S. Pat. No. 2,334,006 disclose motor fuels comprising 25 and 50% vol. of methyl acetate, ethyl formate, ethyl acetate, isopropyl formate, isopropyl acetate, ethyl propionate, secondary butyl acetate and tertiary butyl acetate.

U.S. Pat. No. 3,421,867 discloses hydrocarbon fuels in the gasoline boiling range having a minimum research octane number with 3 cc. of tetraethyl lead per gallon of 102, said fuel containing an organo-lead anti-knock agent in a concentration of at least 0.5 cc. per gallon and 0.1 to 2.0 volume percent of an oxygenated hydrocarbon selected from the group consisting of t-alkyl esters of a hydrocarbyl monocarboxylic acid, said monocarboxylic acid containing from 1 to 30 carbon atoms. It is disclosed that said oxygenated hydrocarbon effects a substantial improvement in the research octane number of the fuel.

WO-A-94/21753 discloses fuels for internal combustion engines, including both gasoline and diesel fuel, containing proportions (e.g. 1 to 90% v, 1 to 50% v, preferably 1 to 20% v) of esters of C₄₋₆ keto-carbonic acids, preferably levulinic acid, with C₁₋₂₂ alcohols. Esters with C₁₋₈ alcohols are described as being particularly suitable for inclusion in gasolines, and esters with C₉₋₂₂ alcohols are described as being particularly suitable for inclusion in diesel fuels.

The use of esters based on C₄₋₆ keto-carbonic acids, preferably levulinic acid, with C₁₋₂₂ alcohols in liquid fuel compositions has also been suggested in WO-A-03/002696 and WO-A-2005/044960. Ethyl levulinate has been identified as a particularly suitable ester, in particular for use in gasoline and diesel fuel compositions.

It is described in WO-A-2005/044960 that within an engine fuel injection system, the fuel comes into contact with a range of elastomeric materials, in particular fuel pump seals, and that in use, many of these elastomers swell on contact with the fuel to an extent which depends on the chemistry of the fuel. In particular, WO-A-2005/044960 describes that certain elastomers in a fuel injection system tend to equilibrate with a uniform fuel diet and can thus provide with reasonable consistency the required level of sealing, and that they become vulnerable, however, if a change in fuel diet causes any significant change in the degree of elastomer swell. In the worst cases a mixed fuel diet can stress the elastomeric components of an engine to such an extent that fuel leakage results.

For the above reasons, WO-A-2005/044960 describes that it is desirable for a fuel blend to have an overall specification as close as possible to that of the standard commercially available base fuels for which engines tend to be optimised.

However, WO-A-2005/044960 describes that addition of ethyl levulinate to certain liquid fuel compositions has the undesired effect of making the liquid fuel less compatible with certain elastomeric seal materials which are commonly exposed to the fuels, in particular the use of ethyl levulinate in the liquid fuels has been found to cause a surprisingly large change in the volume of the elastomer (elastomer swell), and discloses that the use of C₄₋₈ alkyl levulinates overcomes this problem.

### SUMMARY OF THE INVENTION

The present invention provides a liquid fuel composition comprising a major portion of a base fuel suitable for use in an internal combustion engine and from 0.5 to 25 vol %, based on the liquid fuel composition, of a C1-C5 hydrocarbyl valerate ester composition.

The present invention yet further provides a method of operating an internal combustion engine, which method involves introducing into a combustion chamber of the engine a liquid fuel composition according to the present invention.

### DETAILED DESCRIPTION OF THE INVENTION

It has been found that, while ethyl valerate causes a greater change in the volume of certain elastomeric materials (elastomer swell) than ethyl levulinate, certain blends of liquid base fuels and at least one C1-C5 valerate ester produce liquid fuel compositions which have acceptable compatibility with these elastomeric materials and an improved compatibility with these elastomeric materials (reduced elastomer swell) than equivalent blends of ethyl levulinate with the liquid base fuel.

The liquid fuel compositions of the present invention comprise a liquid base fuel in admixture with a C1-C5 hydrocarbyl valerate ester composition. The liquid base fuel can be selected from any known liquid base fuel suitable for use in an internal combustion engine. Typically, the liquid base fuel is a hydrocarbon liquid base fuel suitable for use in an internal combustion engine. Preferably, the liquid base fuel of the present invention is selected from gasoline base fuel and diesel base fuel.

When the liquid base fuel is a gasoline base fuel, the liquid fuel composition of the present invention is a gasoline composition; likewise, when the liquid base fuel is a diesel base fuel, the liquid fuel composition of the present invention is a diesel fuel composition.

The gasoline base fuel of the present invention may be any gasoline suitable for use in an internal combustion engine of the spark-ignition (petrol) type known in the art.

The gasoline base fuel typically comprises mixtures of hydrocarbons boiling in the range from 25 to 230° C. (EN-ISO 3405), the optimal ranges and distillation curves typically varying according to climate and season of the year. The hydrocarbons in a gasoline base fuel may be derived by any means known in the art, conveniently the hydrocarbons may be derived in any known manner from straight-run gasoline, synthetically-produced aromatic hydrocarbon mixtures, thermally or catalytically cracked hydrocarbons, hydro-cracked petroleum fractions, catalytically reformed hydrocarbons or mixtures of these.

The specific distillation curve, hydrocarbon composition, research octane number (RON) and motor octane number (MON) of the gasoline base fuel are not critical.

Conveniently, the research octane number (RON) of the gasoline base fuel may be at least 80, for instance in the range of from 80 to 110, preferably the RON of the gasoline base fuel will be at least 90, for instance in the range of from 90 to 110, more preferably the RON of the gasoline base fuel will be at least 91, for instance in the range of from 91 to 105, even more preferably the RON of the gasoline base fuel will be at least 92, for instance in the range of from 92 to 103, even more preferably the RON of the gasoline base fuel will be at least 93, for instance in the range of from 93 to 102, and most preferably the RON of the gasoline base fuel will be at least 94, for instance in the range of from 94 to 100 (EN 25164); the motor octane number (MON) of the gasoline base fuel may conveniently be at least 70, for instance in the range of from 70 to 110, preferably the MON of the gasoline base fuel will be at least 75, for instance in the range of from 75 to 105, more preferably the MON of the gasoline base fuel will be at least 80, for instance in the range of from 80 to 100, most preferably the MON of the gasoline base fuel will be at least 82, for instance in the range of from 82 to 95 (EN 25163).

Typically, gasoline base fuels comprise components selected from one or more of the following groups; saturated hydrocarbons, olefinic hydrocarbons, aromatic hydrocarbons, and oxygenated hydrocarbons. Conveniently, the gasoline base fuel may comprise a mixture of saturated hydrocarbons, olefinic hydrocarbons, aromatic hydrocarbons, and, optionally, oxygenated hydrocarbons.

Typically, the olefinic hydrocarbon content of the gasoline base fuel is in the range of from 0 to 40 percent by volume based on the gasoline base fuel (ASTM D1319); preferably, the olefinic hydrocarbon content of the gasoline base fuel is in the range of from 0 to 30 percent by volume based on the gasoline base fuel, more preferably, the olefinic hydrocarbon content of the gasoline base fuel is in the range of from 0 to 20 percent by volume based on the gasoline base fuel.

Typically, the aromatic hydrocarbon content of the gasoline base fuel is in the range of from 0 to 70 percent by volume based on the gasoline base fuel (ASTM D1319), for instance the aromatic hydrocarbon content of the gasoline base fuel is in the range of from 10 to 60 percent by volume based on the gasoline base fuel; preferably, the aromatic hydrocarbon content of the gasoline base fuel is in the range of from 0 to 50 percent by volume based on the gasoline base fuel, for instance the aromatic hydrocarbon content of the gasoline base fuel is in the range of from 10 to 50 percent by volume based on the gasoline base fuel.

The benzene content of the gasoline base fuel is at most 10 percent by volume, more preferably at most 5 percent by volume, especially at most 1 percent by volume based on the gasoline base fuel.

The gasoline base fuel preferably has a low or ultra low sulphur content, for instance at most 1000 ppmw (parts per million by weight), preferably no more than 500 ppmw, more preferably no more than 100, even more preferably no more than 50 and most preferably no more than even 10 ppmw.

The gasoline base fuel also preferably has a low total lead content, such as at most 0.005 g/l, most preferably being lead free—having no lead compounds added thereto (i.e. unleaded).

When the gasoline base fuel comprises oxygenated hydrocarbons, at least a portion of non-oxygenated hydrocarbons will be substituted for oxygenated hydrocarbons. The oxygen content of the gasoline base fuel may be up to 35 percent by weight (EN 1601) (e.g. ethanol per se) based on the gasoline base fuel. For example, the oxygen content of the gasoline base fuel may be up to 25 percent by weight, preferably up to 10 percent by weight. Conveniently, the oxygenate concentration will have a minimum concentration selected from any one of 0, 0.2, 0.4, 0.6, 0.8, 1.0, and 1.2 percent by weight, and a maximum concentration selected from any one of 5, 4.5, 4.0, 3.5, 3.0, and 2.7 percent by weight.

Examples of oxygenated hydrocarbons that may be incorporated into the gasoline base fuel include alcohols, ethers, esters (other than C1-C5 hydrocarbyl valerate esters), ketones, aldehydes, carboxylic acids and their derivatives, and oxygen containing heterocyclic compounds. Preferably, the oxygenated hydrocarbons that may be incorporated into the gasoline base fuel are selected from alcohols (such as methanol, ethanol, propanol, iso-propanol, butanol, tert-butanol and iso-butanol) and ethers (preferably ethers containing 5 or more carbon atoms per molecule, e.g., methyl tert-butyl ether), a particularly preferred oxygenated hydrocarbon is ethanol.

When oxygenated hydrocarbons are present in the gasoline base fuel, the amount of oxygenated hydrocarbons in the gasoline base fuel may vary over a wide range. For example, gasolines comprising a major proportion of oxygenated hydrocarbons are currently commercially available in countries such as Brazil and U.S.A, e.g. ethanol per se and E85, as well as gasolines comprising a minor proportion of oxygenated hydrocarbons, e.g. E10 and E5. Therefore, the gasoline base fuel may contain up to 100 percent by volume oxygenated hydrocarbons. Preferably, the amount of oxygenated hydrocarbons present in the gasoline base fuel is selected from one of the following amounts: up to 85 percent by volume; up to 65 percent by volume; up to 30 percent by volume; up to 20 percent by volume; up to 15 percent by volume; and, up to 10 percent by volume, depending upon the desired final formulation of the gasoline. Conveniently, the gasoline base fuel may contain at least 0.5, 1.0 or 2.0 percent by volume oxygenated hydrocarbons.

Examples of suitable gasoline base fuels include gasoline base fuels which have an olefinic hydrocarbon content of from 0 to 20 percent by volume (ASTM D1319), an oxygen content of from 0 to 5 percent by weight (EN 1601), an aromatic hydrocarbon content of from 0 to 50 percent by volume (ASTM D1319) and a benzene content of at most 1 percent by volume.

Whilst not critical to the present invention, the gasoline composition may conveniently additionally include one or more fuel additive. The concentration and nature of the fuel additive(s) that may be included in the gasoline composition of the present invention is not critical. Non-limiting examples of suitable types of fuel additives that can be included in the gasoline composition include anti-oxidants, corrosion inhibitors, detergents, dehazers, antiknock additives, metal deactivators, valve-seat recession protectant compounds, dyes, friction modifiers, carrier fluids, diluents and markers. Examples of suitable such additives are described generally in U.S. Pat. No. 5,855,629.

Conveniently, the fuel additives can be blended with one or more diluents or carrier fluids, to form an additive concentrate, the additive concentrate can then be admixed with the gasoline composition or gasoline base fuel.

The (active matter) concentration of any additives present in the gasoline base fuel or the gasoline composition is preferably up to 1 percent by weight, more preferably in the range from 5 to 1000 ppmw, advantageously in the range of from 75 to 300 ppmw, such as from 95 to 150 ppmw.

The diesel base fuel of the present invention includes diesel fuels for use in automotive compression ignition engines, as well as in other types of engine such as for example marine, railroad and stationary engines.

The diesel base fuel may itself comprise a mixture of two or more different diesel fuel components, and/or be additivated as described below.

Such diesel base fuels will contain one or more base fuels which may typically comprise liquid hydrocarbon middle distillate gas oil(s), for instance petroleum derived gas oils. Such fuels will typically have boiling points within the usual diesel range of 150 to 400° C., depending on grade and use. They will typically have a density from 750 to 1000 kg/m³, preferably from 780 to 860 kg/m³, at 15° C. (e.g. ASTM D4502 or IP 365) and a cetane number (ASTM D613) of from 35 to 120, more preferably from 40 to 85. They will typically have an initial boiling point in the range 150 to 230° C. and a final boiling point in the range 290 to 400° C. Their kinematic viscosity at 40° C. (ASTM D445) might suitably be from 1.2 to 4.5 mm²/s.

An example of a petroleum derived gas oil is a Swedish Class 1 base fuel, which will have a density from 800 to 820 kg/m³ at 15° C. (SS-EN ISO 3675, SS-EN ISO 12185), a T95 of 320° C. or less (SS-EN ISO 3405) and a kinematic viscosity at 40° C. (SS-EN ISO 3104) from 1.4 to 4.0 mm²/s, as defined by the Swedish national specification EC1.

Optionally, non-mineral oil based fuels, such as biofuels or Fischer-Tropsch derived fuels, may also form or be present in the diesel base fuel. Such Fischer-Tropsch fuels may for example be derived from natural gas, natural gas liquids, petroleum or shale oil, petroleum or shale oil processing residues, coal or biomass.

The amount of Fischer-Tropsch derived fuel used in the diesel base fuel may be from 0% to 100% v of the overall diesel base fuel, preferably from 5% to 100% v, more preferably from 5% to 75% v. It may be desirable for such a diesel base fuel to contain 10% v or greater, more preferably 20% v or greater, still more preferably 30% v or greater, of the Fischer-Tropsch derived fuel. It is particularly preferred for such diesel base fuels to contain 30 to 75% v, and particularly 30 or 70% v, of the Fischer-Tropsch derived fuel. The balance of the diesel base fuel is made up of one or more other diesel fuel components.

Such a Fischer-Tropsch derived fuel component is any fraction of the middle distillate fuel range, which can be isolated from the (optionally hydrocracked) Fischer-Tropsch synthesis product. Typical fractions will boil in the naphtha, kerosene or gas oil range. Preferably, a Fischer-Tropsch product boiling in the kerosene or gas oil range is used because these products are easier to handle in for example domestic environments. Such products will suitably comprise a fraction larger than 90 wt % which boils between 160 and 400° C., preferably to about 370° C. Examples of Fischer-Tropsch derived kerosene and gas oils are described in EP-A-0583836, WO-A-97/14768, WO-A-97/14769, WO-A-00/11116, WO-A-00/11117, WO-A-01/83406, WO-A-01/83648, WO-A-01/83647, WO-A-01/83641, WO-A-00/20535, WO-A-00/20534, EP-A-1101813, U.S. Pat. No. 5,766,274, U.S. Pat. No. 5,378,348, U.S. Pat. No. 5,888,376 and U.S. Pat. No. 6,204,426.

The Fischer-Tropsch product will suitably contain more than 80 wt % and more suitably more than 95 wt % iso and normal paraffins and less than 1 wt % aromatics, the balance being naphthenics compounds. The content of sulphur and nitrogen will be very low and normally below the detection limits for such compounds. For this reason the sulphur content of a diesel fuel composition containing a Fischer-Tropsch product may be very low.

The diesel fuel composition preferably contains no more than 5000 ppmw sulphur, more preferably no more than 500 ppmw, or no more than 350 ppmw, or no more than 150 ppmw, or no more than 100 ppmw, or no more than 70 ppmw, or no more than 50 ppmw, or no more than 30 ppmw, or no more than 20 ppmw, or most preferably no more than 15 ppmw sulphur.

The diesel base fuel may itself be additivated (additive-containing) or unadditivated (additive-free). If additivated, e.g. at the refinery, it will contain minor amounts of one or more additives selected for example from anti-static agents, pipeline drag reducers, flow improvers (e.g. ethylene/vinyl acetate copolymers or acrylate/maleic anhydride copolymers), lubricity additives, antioxidants and wax anti-settling agents.

Detergent-containing diesel fuel additives are known and commercially available. Such additives may be added to diesel fuels at levels intended to reduce, remove, or slow the build up of engine deposits.

Examples of detergents suitable for use in diesel fuel additives for the present purpose include polyolefin substituted succinimides or succinamides of polyamines, for instance polyisobutylene succinimides or polyisobutylene amine succinamides, aliphatic amines, Mannich bases or amines and polyolefin (e.g. polyisobutylene) maleic anhydrides. Succinimide dispersant additives are described for example in GB-A-960493, EP-A-0147240, EP-A-0482253, EP-A-0613938, EP-A-0557516 and WO-A-98/42808. Particularly preferred are polyolefin substituted succinimides such as polyisobutylene succinimides.

The diesel fuel additive mixture may contain other components in addition to the detergent. Examples are lubricity enhancers; dehazers, e.g. alkoxylated phenol formaldehyde polymers; anti-foaming agents (e.g. polyether-modified polysiloxanes); ignition improvers (cetane improvers) (e.g. 2-ethylhexyl nitrate (EHN), cyclohexyl nitrate, di-tert-butyl peroxide and those disclosed in U.S. Pat. No. 4,208,190 at column 2, line 27 to column 3, line 21); anti-rust agents (e.g. a propane-1,2-diol semi-ester of tetrapropenyl succinic acid, or polyhydric alcohol esters of a succinic acid derivative, the succinic acid derivative having on at least one of its alpha-carbon atoms an unsubstituted or substituted aliphatic hydrocarbon group containing from 20 to 500 carbon atoms, e.g. the pentaerythritol diester of polyisobutylene-substituted succinic acid); corrosion inhibitors; reodorants; anti-wear additives; anti-oxidants (e.g. phenolics such as 2,6-di-tert-butylphenol, or phenylenediamines such as N,N′-di-sec-butyl-p-phenylenediamine); metal deactivators; combustion improvers; static dissipator additives; cold flow improvers; and wax anti-settling agents.

The diesel fuel additive mixture may contain a lubricity enhancer, especially when the diesel fuel composition has a low (e.g. 500 ppmw or less) sulphur content. In the additivated diesel fuel composition, the lubricity enhancer is conveniently present at a concentration of less than 1000 ppmw, preferably between 50 and 1000 ppmw, more preferably between 70 and 1000 ppmw. Suitable commercially available lubricity enhancers include ester- and acid-based additives. Other lubricity enhancers are described in the patent literature, in particular in connection with their use in low sulphur content diesel fuels, for example in:
the paper by Danping Wei and H. A. Spikes, “The Lubricity of Diesel Fuels”, Wear, III (1986) 217-235;
WO-A-95/33805—cold flow improvers to enhance lubricity of low sulphur fuels;
WO-A-94/17160—certain esters of a carboxylic acid and an alcohol wherein the acid has from 2 to 50 carbon atoms and the alcohol has 1 or more carbon atoms, particularly glycerol monooleate and di-isodecyl adipate, as fuel additives for wear reduction in a diesel engine injection system;
U.S. Pat. No. 5,490,864—certain dithiophosphoric diester-dialcohols as anti-wear lubricity additives for low sulphur diesel fuels; and
WO-A-98/01516—certain alkyl aromatic compounds having at least one carboxyl group attached to their aromatic nuclei, to confer anti-wear lubricity effects particularly in low sulphur diesel fuels.

It may also be preferred for the diesel fuel composition to contain an anti-foaming agent, more preferably in combination with an anti-rust agent and/or a corrosion inhibitor and/or a lubricity enhancing additive.

Unless otherwise stated, the (active matter) concentration of each such additive component in the additivated diesel fuel composition is preferably up to 10000 ppmw, more preferably in the range from 0.1 to 1000 ppmw, advantageously from 0.1 to 300 ppmw, such as from 0.1 to 150 ppmw.

The (active matter) concentration of any dehazer in the diesel fuel composition will preferably be in the range from 0.1 to 20 ppmw, more preferably from 1 to 15 ppmw, still more preferably from 1 to 10 ppmw, advantageously from 1 to 5 ppmw. The (active matter) concentration of any ignition improver present will preferably be 2600 ppmw or less, more preferably 2000 ppmw or less, conveniently from 300 to 1500 ppmw. The (active matter) concentration of any detergent in the diesel fuel composition will preferably be in the range from 5 to 1500 ppmw, more preferably from 10 to 750 ppmw, most preferably from 20 to 500 ppmw.

In the case of a diesel fuel composition, for example, the fuel additive mixture will typically contain a detergent, optionally together with other components as described above, and a diesel fuel-compatible diluent, which may be a mineral oil, a solvent such as those sold by Shell companies under the trade mark “SHELLSOL”, a polar solvent such as an ester and, in particular, an alcohol, e.g. hexanol, 2-ethylhexanol, decanol, isotridecanol and alcohol mixtures such as those sold by Shell companies under the trade mark “LINEVOL”, especially LINEVOL 79 alcohol which is a mixture of C₇₋₉ primary alcohols, or a C₁₂₋₁₄ alcohol mixture which is commercially available.

The total content of the additives in the diesel fuel composition may be suitably between 0 and 10000 ppmw and preferably below 5000 ppmw.

In the above, amounts (concentrations, % vol, ppmw, % wt) of components are of active matter, i.e. exclusive of volatile solvents/diluent materials.

By the term “C1-C5 hydrocarbyl valerate ester composition” it is meant a compound or mixture of compounds having formula (I) below:

R—O—C(═O)—CH₂—CH₂—CH₂—CH₃ (I)

wherein R is a C1-C5 hydrocarbyl moiety (i.e. a hydrocarbon moiety having from 1 to 5 carbon atoms), preferably a linear or branched C1-C5 alkyl moiety (i.e. a linear or branched alkyl moiety having from 1 to 5 carbon atoms). Preferred C1-C5 hydrocarbyl valerate esters are methyl valerate, ethyl valerate, propyl valerates, butyl valerates and pentyl valerates.

Conveniently, the C1-C5 hydrocarbyl valerate ester composition may consist of methyl valerate, ethyl valerate, propyl valerate, and mixtures thereof. More conveniently, the C1-C5 hydrocarbyl valerate ester composition may consist of ethyl valerate.

The C1-C5 hydrocarbyl valerate ester composition may conveniently be a linear C1-C5 hydrocarbyl valerate ester composition; by the term “linear C1-C5 hydrocarbyl valerate ester composition”, it is meant that the C1-C5 hydrocarbyl moiety of the ester is a linear hydrocarbyl moiety and is connected to the ester group through a terminal carbon atom of the hydrocarbyl backbone.

If the liquid base fuel is a gasoline base fuel, the C1-C5 hydrocarbyl valerate ester composition is preferably selected from methyl valerate, ethyl valerate, propyl valerates and mixtures thereof; more preferably methyl valerate, ethyl valerate and mixtures thereof; most preferably ethyl valerate.

If the liquid base fuel is a diesel base fuel, the C1-C5 hydrocarbyl valerate ester composition is preferably selected from ethyl valerate, propyl valerates, butyl valerates, pentyl valerates and mixtures thereof; more preferably butyl valerates, pentyl valerates and mixtures thereof.

The method of preparation of the C1-C5 hydrocarbyl valerate esters of the present invention is not critical and they may be prepared by any known method.

The liquid fuel composition of the present invention is produced by admixing a C1-C5 hydrocarbyl valerate ester composition with a liquid base fuel. If the liquid fuel composition is a gasoline composition, then the gasoline composition of the present invention is produced by admixing a C1-C5 hydrocarbyl valerate ester composition with a gasoline base fuel; likewise, if the liquid fuel composition is a diesel fuel composition, then the diesel fuel composition of the present invention is produced by admixing a C1-C5 hydrocarbyl valerate ester composition with a diesel base fuel.

The C1-C5 hydrocarbyl valerate ester composition admixed with the liquid base fuel in the present invention may be present in a concentration in the range of from 0.5 vol. % to 25 vol. %, based on the total volume of the liquid fuel composition. Preferably, the C1-C5 hydrocarbyl valerate ester composition admixed with the liquid base fuel in the present invention may be present in various concentration ranges having a lower limit of from 1 vol. %, preferably from 2 vol. %, more preferably from 2.5 vol. %, more preferably from 3 vol. % or more than 3 vol. %, more preferably from 3.5 vol. %, and an upper limit of at most 20 vol. %, preferably 19 vol. %, more preferably 18 vol. %, more preferably 17 vol. %, more preferably 16 vol. %, more preferably 15 vol. %, based on the total volume of the liquid fuel composition.

For example, the concentration of the C1-C5 hydrocarbyl valerate ester composition admixed with the liquid base fuel in the present invention may be in any one of the following ranges: 0.5 to 25 vol. %, 0.5 to 20 vol. %, 0.5 to 19 vol. %, 0.5 to 18 vol. %, 0.5 to 17 vol. %, 0.5 to 16 vol. %, 0.5 to 15 vol. %, 1 to 25 vol. %, 1 to 20 vol. %, 1 to 19 vol. %, 1 to 18 vol. %, 1 to 17 vol. %, 1 to 16 vol. %, 1 to 15 vol. %, 2 to 25 vol. %, 2 to 20 vol. %, 2 to 19 vol. %, 2 to 18 vol. %, 2 to 17 vol. %, 2 to 16 vol. %, 2 to 15 vol. %, 2.5 to 25 vol. %, 2.5 to 20 vol. %, 2.5 to 19 vol. %, 2.5 to 18 vol. %, 2.5 to 17 vol. %, 2.5 to 16 vol. %, 2.5 to 15 vol. %, 3 to 25 vol. %, 3 to 20 vol. %, 3 to 19 vol. %, 3 to 18 vol. %, 3 to 17 vol. %, 3 to 16 vol. %, 3 to 15 vol. %, more than 3 vol % to 25 vol. %, more than 3 vol % to 20 vol. %, more than 3 vol % to 19 vol. %, more than 3 vol % to 18 vol. %, more than 3 vol % to 17 vol. %, more than 3 vol % to 16 vol. %, more than 3 vol % to 15 vol. %, 3.5 to 25 vol. %, 3.5 to 20 vol. %, 3.5 to 19 vol. %, 3.5 to 18 vol. %, 3.5 to 17 vol. %, 3.5 to 16 vol. %, and 3.5 to 15 vol. %.

The present invention further provides the use of a concentration of from 0.5 to 25 vol % of a C1-C5 hydrocarbyl valerate ester composition in a liquid fuel composition comprising a major portion of a base fuel suitable for use in an internal combustion engine, to prepare a liquid fuel composition having improved compatibility with certain elastomeric materials in comparison with equivalent liquid fuel compositions comprising an equivalent concentration of a C1-C5 hydrocarbyl levulinate ester composition instead of the C1-C5 hydrocarbyl valerate ester composition.

It has been found that liquid fuel compositions according to the present invention have acceptable compatibility with certain elastomeric materials, and in particular have improved compatibility with certain elastomeric materials in comparison with equivalent liquid fuel compositions comprising an equivalent concentration of a C1-C5 hydrocarbyl levulinate ester composition, in particular ethyl levulinate, instead of the C1-C5 hydrocarbyl valerate ester composition.

By the phrase “acceptable compatibility with certain elastomeric materials” it is meant that the relative volume change of the elastomeric material when exposed to a liquid fuel composition according to the present invention is no greater than a 15% change in volume relative to the volume of the same elastomeric material when exposed to the liquid base fuel (i.e. no more than 15% greater, or no less than 15% less, than the volume of the same elastomeric material when it has been exposed to the liquid base fuel of said liquid fuel composition). For example, if the elastomeric material when exposed to the liquid base fuel has a volume increase of 10% (i.e. the volume of the elastomeric material exposed to the liquid base fuel is 110% of the initial volume of the elastomeric material), then for the liquid fuel composition according to the present invention to have “acceptable compatibility with certain elastomeric materials”, the volume of the elastomeric material when exposed to said liquid fuel composition has to have no greater than a 15% change in volume relative to the volume of the same elastomeric material when exposed to the liquid base fuel (i.e. the volume of the elastomeric material exposed to the liquid fuel composition according to the present invention is in the range of from 93.5 to 126.5% of the initial volume of the elastomeric material).

By the phrase “improved compatibility with certain elastomeric materials in comparison with equivalent liquid fuel compositions comprising an equivalent concentration of a C1-C5 hydrocarbyl levulinate ester composition, in particular ethyl levulinate, instead of the C1-C5 hydrocarbyl valerate ester composition” it is meant that the relative volume change of the elastomeric material when exposed to a liquid fuel composition according to the present invention relative to the volume of the same elastomeric material when exposed to the liquid base fuel is less than the relative volume change of the elastomeric material when exposed to an equivalent liquid fuel composition comprising an equivalent concentration of a C1-C5 hydrocarbyl levulinate ester composition, in particular ethyl levulinate, instead of the C1-C5 hydrocarbyl valerate ester composition, relative to the volume of the same elastomeric material when exposed to the liquid base fuel.

As an additional benefit of the liquid fuel compositions of the present invention, it has been observed that the level of water pick-up over time of liquid fuel compositions of the present invention may be significantly lower than the level of water pick-up over time of liquid fuel compositions containing wherein an equivalent concentration of ethyl levulinate or ethanol is used in substitution for the C1-C5 hydrocarbyl valerate ester composition.

The present invention therefore also provides the use of a concentration of from 0.5 to 25 vol % of a C1-C5 hydrocarbyl valerate ester composition in a liquid fuel composition comprising a major portion of a base fuel suitable for use in an internal combustion engine, to prepare a liquid fuel composition having acceptable compatibility with certain elastomeric materials, in particular to prepare a liquid fuel composition having improved compatibility with certain elastomeric materials in comparison with equivalent liquid fuel compositions comprising an equivalent concentration of a C1-C5 hydrocarbyl levulinate ester composition instead of the C1-C5 hydrocarbyl valerate ester composition. The use of a C1-C5 hydrocarbyl valerate ester composition in a liquid fuel composition comprising a major portion of a base fuel suitable for use in an internal combustion engine, to prepare a liquid fuel composition additionally having a lower tendency to pick up water over time than when an equivalent concentration of ethanol or ethyl levulinate is used in substitution for the C1-C5 hydrocarbyl valerate ester composition. The preferred concentrations of the C1-C5 hydrocarbyl valerate ester composition and the preferred base fuels are as described above.

The present invention further provides a method of preparing a liquid fuel composition having acceptable compatibility with certain elastomeric materials, comprising admixing a base fuel suitable for use in an internal combustion engine with from 0.5 to 25 vol %, based on the liquid fuel composition, of a C1-C5 hydrocarbyl valerate ester composition. The preferred concentrations of the C1-C5 hydrocarbyl valerate ester composition and the preferred base fuels are as described above.

The present invention further provides a method of operating an internal combustion engine, which method involves introducing into a combustion chamber of the engine a liquid fuel composition according to the present invention.

The present invention will be further understood from the following examples. Unless otherwise stated, all amounts and concentrations disclosed in the examples are based on volume of the fully formulated fuel composition.

### EXAMPLES

### Elastomer Compatibility

The effect of various test liquids on elastomer seals was assessed using a test procedure based on ISO 1817:1998. The volume and average hardness of elastomer samples cut from sheets of elastomer material of 3 mm thickness, nominally 50 mm×25 mm×3 mm thickness, were measured both before and after immersion in the test liquid at a specified temperature for a specified period of time.

For each test liquid, three test pieces were cut and the following test was performed in triplicate. After cutting the test piece, the surface of the test material was wiped with a lint-free cloth to remove any surface material. A small hole was then made in the centre of the short side of the test piece, approximately 3 mm from the edge, and a piece of wire threaded through and made into a loop.

The appearance of each test piece and the appearance of each of the test liquids were recorded after visual inspection.

The initial hardness of each of the test pieces was measured using a Shore Durometer (Type A, Serial No. 000865, Durotech). This involves placing the test piece on the sample pad, positioning the Durometer perpendicularly above the test piece and then applying gentle pressure to the top pad such the needle deflects. The reading recorded on the gauge is the hardness measurement in Shore Points.

The mass of each test piece was then weighed in air to the nearest mg. This value is denoted as M1. Each test piece was then re-weighed but suspending the test piece in a beaker of distilled water. This value is denoted as M2.

Each test piece was then dried. The test pieces were then placed (in triplicate) in a 4 oz glass bottle containing sufficient volume of the test liquid to be greater than 15× combined volume of test pieces and to keep them totally immersed.

The test pieces were then stored in the test liquids for a specified period of time under specified conditions.

If the test pieces were stored under ambient conditions, these pieces were removed from the test liquid and blotted with lint-free paper. If the test pieces were stored under elevated temperature conditions, the test pieces were first transferred to a fresh portion of the test liquid at ambient temperature for a period of between 10 and 30 minutes prior to this drying process.

The final hardness of the test pieces was determined using the same procedure and apparatus as used to determine initial hardness, again recording the hardness measurement as Shore Points. The change in hardness as a consequence of exposure to the test liquid is expressed in terms of percentage change:—

Hardness Change=((Final Hardness−Initial Hardness)/Initial Hardness)×100%

Note. A negative hardness change indicates an elastomer has become softened due to exposure to a test liquid and a positive hardness change indicates that the elastomer has become hardened due to exposure to a test liquid.

The mass of each test piece was determined in air and in water as before, with these values denoted as M3 and M4.

The volume change for a test piece is calculated from the mass measurements made in air and in water before and after exposure to the test liquid, using the following equation:—

Volume Change=(((M3−M4)−(M1−M2))/(M1−M2))×100%

Note. A negative volume change indicates an elastomer has shrunk due to exposure to a test liquid and a positive volume change indicates that the elastomer has swollen due to exposure to a test liquid.

Two elastomer materials were chosen to be representative of the seals (O-rings, etc.) used in modern fuel systems: LR 6316 (a fluorocarbon tetrapolymer also known as Viton (trade mark) and Elast-O-Lion R280 (EOL R280) (a hydrogenated nitrile polymer) (both ex. James Walker & Co. Ltd., UK).

### Examples A to D

The effect of ethyl valerate (EV) (ex Aldrich, 98% Grade) and ethyl levulinate (EL) (ex Shanghai Pu Jie) on elastomer seal materials was assessed and the results are given in Table 1 below. The elastomer test pieces were stored in the test liquids for 7 days (168 hours) at ambient temperature.

TABLE 1

| | Test | Volume | | | Hardness | | |
|---|---|---|---|---|---|---|---|
| Example | Liquid | Initial | Final | % Change | Initial | Final | % Change |

LR 6316 (Viton)

| | | | | | | | |
|---|---|---|---|---|---|---|---|
| A* | EV | 3.65 | 8.13 | 123.7 | 81 | 61 | −25.0 |
| B* | EL | 3.97 | 6.83 | 72.0 | 80 | 61 | −23.7 |

EOL 280 (Hydrogenated nitrile)

| | | | | | | | |
|---|---|---|---|---|---|---|---|
| C* | EV | 3.97 | 5.77 | 45.2 | 82 | 62 | −25.1 |
| D* | EL | 3.78 | 7.52 | 99.1 | 82 | 57 | −30.4 |

*Not of the invention

It can be seen from Table 1 that ethyl valerate caused a greater change in volume of the LR 6316 elastomer and a comparable change in hardness of the LR 6316 elastomer compared to ethyl levulinate. It can also be seen from Table 1 that ethyl valerate caused a lesser change in volume and hardness of the EOL R280 elastomer than ethyl levulinate.

### Examples 1 to 4 and Examples E to H

The effect of base gasoline (ULG), gasoline containing 5% vol. ethyl valerate (EV5), gasoline containing 5% vol. methyl valerate (MV5) and gasoline containing 5% vol. ethyl levulinate (EL5) on elastomer seal materials was assessed and the results are given in Table 2 below.

The base gasoline used in Examples 1 to 4 and Examples E to H was an unleaded gasoline base fuel (ULG-95), having a sulphur content (ISO 20884) of 30.7 ppmw, aromatics content of 35.02% v/v and olefins content of 14.64% v/v (GC analysis; LTP/36), density at 15° C. (IP 365) 742.6 kg/m³, distillation (IP 123) IBP 30.2° C., 10% 46.1° C., 50% 102.1° C., 90% 159.5° C. and FBP 202.0° C. The elastomer test pieces were stored in the test liquids for 7 days (168 hours) at ambient temperature.

TABLE 2

| | Test | Volume | | | Hardness | | |
|---|---|---|---|---|---|---|---|
| Example | Liquid | Initial | Final | % Change | Initial | Final | % Change |

LR 6316 (Viton)

| | | | | | | | |
|---|---|---|---|---|---|---|---|
| E* | ULG | 3.94 | 4.01 | 1.9 | 80 | 75 | −5.8 |
| 1 | EV5 | 3.71 | 3.83 | 3.1 | 80 | 75 | −6.3 |
| 2 | MV5 | 3.98 | 4.12 | 3.4 | 83 | 79 | −4.4 |
| F* | EL5 | 3.85 | 4.25 | 10.5 | 81 | 71 | −12.4 |

EOL 280 (Hydrogenated nitrile)

| | | | | | | | |
|---|---|---|---|---|---|---|---|
| G* | ULG | 3.90 | 4.86 | 24.8 | 82 | 67 | −17.6 |
| 3 | EV5 | 3.91 | 4.90 | 25.5 | 82 | 66 | −19.8 |
| 4 | MV5 | 3.87 | 4.88 | 26.1 | 85 | 67 | −20.8 |
| H* | EL5 | 3.70 | 5.02 | 35.5 | 82 | 64 | −21.5 |

*Not of the invention

It can be seen from Table 2 that surprisingly gasoline compositions containing 5% vol. ethyl valerate and gasoline compositions containing 5% vol. methyl valerate caused a lesser change in volume of both the LR 6316 elastomer and the EOL R280 elastomer and a lesser change in hardness of both the LR 6316 elastomer and the EOL R280 elastomer compared to gasoline compositions containing 5% vol. ethyl levulinate. It can also be seen from Table 2 that gasoline compositions containing 5% vol. ethyl valerate and gasoline compositions containing 5% vol. methyl valerate only caused a small relative change in volume and hardness of both elastomers in comparison to the base gasoline.

### Examples 5 to 8 and Examples I to L

The effect of base diesel fuel (ZSD), diesel fuel containing 5% vol. ethyl valerate (EV5), diesel fuel containing 5% vol. iso-butyl valerate (BV5) (ex Augustus Oils) and diesel fuel containing 3% vol. ethyl levulinate (EL3) on elastomer seal materials was assessed and the results are given in Table 3 below.

The base diesel fuel used in Examples 5 to 8 and Examples I to L was a zero sulphur diesel base fuel (ZSD), having a sulphur content (ISO 12156) 10 ppmw, aromatics content (IP 391) of 30.3% v/v, density at 15° C. (IP 365) 838.9 kg/m³, distillation (IP 123) IBP 164.9° C., 10% 214.9° C., 50% 280.6° C., 90% 329.9° C. and FBP 355.6° C.

The elastomer test pieces were stored in the test liquids for 7 days (168 hours) at a temperature of 70° C.

TABLE 3

| | Test | Volume | | | Hardness | | |
|---|---|---|---|---|---|---|---|
| Example | Liquid | Initial | Final | % Change | Initial | Final | % Change |

LR 6316 (Viton)

| | | | | | | | |
|---|---|---|---|---|---|---|---|
| I* | ZSD | 3.89 | 3.95 | 1.3 | 80 | 76 | −5.4 |
| 5 | EV5 | 3.74 | 3.88 | 3.6 | 80 | 74 | −7.1 |
| 6 | BV5 | 3.91 | 4.02 | 2.8 | 83 | 80 | −3.2 |
| J* | EL3 | 3.72 | 4.01 | 7.7 | 80 | 72 | −10.0 |

EOL 280 (Hydrogenated nitrile)

| | | | | | | | |
|---|---|---|---|---|---|---|---|
| K* | ZSD | 3.67 | 4.02 | 9.3 | 83 | 74 | −10.1 |
| 7 | EV5 | 3.92 | 4.36 | 11.2 | 82 | 73 | −11.4 |
| 8 | BV5 | 3.84 | 4.28 | 11.5 | 85 | 76 | −10.6 |
| L* | EL3 | 3.65 | 4.29 | 17.4 | 82 | 68 | −16.7 |

*Not of the invention

It can be seen from Table 3 that surprisingly diesel fuel compositions containing 5% vol. ethyl valerate and diesel fuel compositions containing 5% vol. iso-butyl valerate caused a lesser change in volume of both the LR 6316 elastomer and the EOL R280 elastomer, and a lesser change in hardness of both the LR 6316 elastomer and the EOL R280 elastomer compared to diesel fuel compositions containing 3% vol. ethyl levulinate. It can also be seen from Table 3 that diesel fuel compositions containing 5% vol. ethyl valerate and diesel fuel compositions containing 5% vol. iso-butyl valerate only caused a small relative change in volume and hardness of both elastomers in comparison to the base diesel fuel.

### Examples 9 to 16 and Examples M to P

The effect of base gasoline (ULG) and gasoline compositions containing concentrations of 5, 10, 15, 25 and 50% vol. of ethyl valerate (EV5, EV10, EV15, EV25 and EV50 respectively) on elastomer seal materials was assessed and the results are given in Table 4 below.

The base gasoline used in Examples 9 to 16 and Examples M to P was an unleaded gasoline base fuel (ULG-95), having a sulphur content (ISO 20884) of 32 ppmw, aromatics content of 34.93% v/v and olefins content of 13.75% v/v (GC analysis; LTP/36), density at 15° C. (IP 365) 744.1 kg/m³, distillation (IP 123) IBP 32.1° C., 10% 50.6° C., 50% 99.9° C., 90% 156.0° C. and FBP 197.0° C. The elastomer test pieces were stored in the test liquids for 7 days (168 hours) at ambient temperature.

TABLE 4

| | Test | Volume | | | Hardness | | |
|---|---|---|---|---|---|---|---|
| Example | Liquid | Initial | Final | % Change | Initial | Final | % Change |

LR 6316 (Viton)

| | | | | | | | |
|---|---|---|---|---|---|---|---|
| M* | ULG | 3.99 | 4.10 | 2.7 | 80 | 75 | −6.3 |
| 9 | EV5 | 3.97 | 4.13 | 4.0 | 79 | 75 | −5.5 |
| 10 | EV10 | 3.84 | 4.07 | 6.0 | 80 | 73 | −8.4 |
| 11 | EV15 | 3.83 | 4.17 | 8.7 | 80 | 71 | −10.9 |
| 12 | EV25 | 4.02 | 4.74 | 18.1 | 80 | 65 | −18.0 |
| N* | EV50 | 3.90 | 6.27 | 60.9 | 80 | 55 | −31.4 |

EOL 280 (Hydrogenated nitrile)

| | | | | | | | |
|---|---|---|---|---|---|---|---|
| O* | ULG | 3.76 | 4.75 | 26.3 | 85 | 70 | −18.0 |
| 13 | EV5 | 3.75 | 4.77 | 27.2 | 85 | 70 | −18.0 |
| 14 | EV10 | 3.72 | 4.75 | 27.7 | 85 | 70 | −18.4 |
| 15 | EV15 | 3.84 | 4.91 | 27.8 | 85 | 69 | −18.8 |
| 16 | EV25 | 3.81 | 4.94 | 29.5 | 85 | 69 | −18.4 |
| P* | EV50 | 3.97 | 5.31 | 33.7 | 85 | 68 | −20.3 |

*Not of the invention

It can be seen from Table 4 that increasing the ethyl valerate concentration in the gasoline compositions caused relatively little change in volume and hardness of the EOL R280 elastomer compared to the base gasoline. However, increasing the ethyl valerate concentration in the gasoline compositions to a concentration of above 25% vol. caused a significant relative change in volume of the LR 6316 elastomer compared to the base gasoline.

### Water Pick-Up

### Examples Q to S

The tendency of ethyl valerate (EV) to pick up water was assessed and compared to ethanol (EtOH), which is a commonly used oxygenate component in gasoline compositions, and ethyl levulinate (EL), which has been suggested as a suitable component for use in both gasoline and diesel fuel compositions.

In order to assess the tendency of ethyl valerate, ethanol and ethyl levulinate to pick up water, the Karl Fischer method (ASTM D1364) was used. To assess the initial water content of the liquids, a 50 ml sample of each of the three liquids and the water content was assessed using the Karl Fischer method. The initial water content of the three liquids was 0.13% wt. for ethyl valerate, 0.23% vol. for ethanol and 0.07% vol. for ethyl levulinate. At the same time as the samples for initial water content assessment were taken, three 500 ml Duran Schott glass bottles were filled with 300 to 500 ml samples of the ethyl valerate, ethanol and ethyl levulinate. The bottles of the three liquids were stored such that were open to the environment and 50 ml aliquots of the liquids were taken for water content analysis using the Karl Fischer method at 4 days, 7 days, 2 weeks, 3 weeks and 4 weeks in order to assess the increase in water content of the three liquids. The increase in water content (from the initial water content) over time of the three liquids is presented in Table 5 below.

TABLE 5

| | | Increase in Water Content (% wt.) | | | | |
|---|---|---|---|---|---|---|
| | | | | | | 4 |
| Example | Liquid | 4 Days | 7 Days | 2 Weeks | 3 Weeks | Weeks |
| Q* | EV | 0.04 | 0.07 | 0.09 | 0.08 | 0.09 |
| R* | EtOH | 0.19 | 0.28 | 0.63 | 1.15 | 2.01 |
| S* | El | 0.28 | 0.28 | 0.50 | 0.79 | 1.04 |

*Not of the invention

It can clearly be seen from Table 5 that ethyl valerate has a lower tendency to pick up water over time than both ethanol and ethyl levulinate.

### Examples 17 to 22 and Example T

Using a method similar to that described above, the tendency of gasoline compositions containing varying amounts and grades of ethyl valerate to pick up water over a time period of 18 weeks was assessed.

The base gasoline used in Examples 13 to 18 and Example T was an unleaded gasoline base fuel (ULG-95), having a sulphur content (ISO 20884) of 30.7 ppmw, aromatics content of 35.02% v/v and olefins content of 14.64% v/v (GC analysis; LTP/36), density at 15° C. (IP 365) 742.6 kg/m³, distillation (IP 123) IBP 30.2° C., 10% 46.1° C., 50% 102.1° C., 90% 159.50° C. and FBP 202.0° C.

The gasoline compositions prepared are described in Table 6 below.

TABLE 6

| Fuel | Gasoline Base Fuel (% vol.) | Ethyl Valerate (% vol.) |
|---|---|---|
| ULG95 | 100 | 0 |
| 1 | 95 | 5* |
| 2 | 90 | 10* |
| 3 | 80 | 20* |
| 4 | 95 | 5** |
| 5 | 90 | 10** |
| 6 | 80 | 20** |

*ex Aldrich, 99% Grade
**ex Aldrich, 98% Grade

TABLE 7

| | | Water Content (ppmw) | | |
|---|---|---|---|---|
| Example | Fuel | Initial | 18 weeks | Change |
| T* | ULG95 | 45 | 60 | 25 |
| 17 | 1 | 95 | 80 | −15 |
| 18 | 2 | 130 | 110 | 20 |
| 19 | 3 | 180 | 175 | −5 |
| 20 | 4 | 130 | 70 | −60 |
| 21 | 5 | 205 | 110 | −95 |
| 22 | 6 | 245 | 285 | 40 |

*Not of the invention.

It can be seen from Table 7 that the gasoline compositions containing ethyl valerate do not show a significant tendency to pick up water (i.e. increase in water content) over time.

We claim:

1. A liquid fuel composition comprising a major portion of a base fuel suitable for use in an internal combustion engine and from 0.5 to 25 vol %, based on the liquid fuel composition, of a C1-C5 hydrocarbyl valerate ester composition.

2. The liquid fuel composition of claim 1 wherein the C1-C5 hydrocarbyl valerate ester composition is selected from the group consisting of methyl valerate, ethyl valerate, propyl valerate, and mixtures thereof.

3. The liquid fuel composition of claim 2 wherein the C1-C5 hydrocarbyl valerate ester composition is ethyl valerate.

4. The liquid fuel composition of claim 1 wherein the C1-C5 hydrocarbyl valerate ester composition is a linear C1-C5 hydrocarbyl valerate ester composition.

5. The liquid fuel composition of claim 1 wherein the concentration of the C1-C5 hydrocarbyl valerate ester composition in the liquid fuel composition is from 1 to 20 vol %.

6. The liquid fuel composition of claim 5 wherein the concentration of the C1-C5 hydrocarbyl valerate ester composition in the liquid fuel composition is from 2 to 18 vol %.

7. The liquid fuel composition of claim 6 wherein the concentration of the C1-C5 hydrocarbyl valerate ester composition in the liquid fuel composition is from 3 to 16 vol %.

8. The liquid fuel composition of claim 7 wherein the concentration of the C1-C5 hydrocarbyl valerate ester composition in the liquid fuel composition is from more than 3 vol % to 16 vol %.

9. The liquid fuel composition of claim 8 wherein the concentration of the C1-C5 hydrocarbyl valerate ester composition in the liquid fuel composition is from 3.5 to 15 vol %.

10. The liquid fuel composition of claim 2 wherein the concentration of the C1-C5 hydrocarbyl valerate ester composition in the liquid fuel composition is from 1 to 20 vol %.

11. The liquid fuel composition of claim 10 wherein the concentration of the C1-C5 hydrocarbyl valerate ester composition in the liquid fuel composition is from 2 to 18 vol %.

12. The liquid fuel composition of claim 11 wherein the concentration of the C1-C5 hydrocarbyl valerate ester composition in the liquid fuel composition is from 3 to 16 vol %.

13. The liquid fuel composition of claim 12 wherein the concentration of the C1-C5 hydrocarbyl valerate ester composition in the liquid fuel composition is from more than 3 vol % to 16 vol %.

14. The liquid fuel composition of claim 13 wherein the concentration of the C1-C5 hydrocarbyl valerate ester composition in the liquid fuel composition is from 3.5 to 15 vol %.

15. The liquid fuel composition of claim 1 wherein the base fuel is a gasoline base fuel.

16. The liquid fuel composition of claim 15 wherein the gasoline base fuel has a research octane number (RON) greater than 90 and a motor octane number (MON) greater than 80.

17. The liquid fuel composition of claim 1 wherein the base fuel is a diesel base fuel.

18. The liquid fuel composition of claim 17 wherein the diesel base fuel has a cetane number in the range of from 35 to 120.

19. A liquid fuel composition comprising a major portion of a base fuel suitable for use in an internal combustion engine and from 1 to 20 vol %, based on the liquid fuel composition, of at least one linear C1-C5 hydrocarbyl valerate ester.

20. The liquid fuel composition of claim 19 wherein the linear C1-C5 hydrocarbyl valerate ester is ethyl valerate.

21. The liquid fuel composition of claim 19 wherein the linear C1-C5 hydrocarbyl valerate ester is methyl valerate.

22. A method of operating an internal combustion engine, which method involves introducing into a combustion chamber of the engine a liquid fuel composition of claim 1.

23. A method of operating an internal combustion engine, which method involves introducing into a combustion chamber of the engine a liquid fuel composition of claim 2.

24. A method of operating an internal combustion engine, which method involves introducing into a combustion chamber of the engine a liquid fuel composition of claim 19.
